(19) United States
(12) Patent Application Publication
(10) Pub. No.: US 2014/0169034 A1
(43) Pub. Date: Jun. 19, 2014

(54) EDGE-TYPE BACKLIGHTING MODULE HAVING LIGHT COUPLERS BETWEEN LIGHT GUIDING PLATE AND LEDS

(71) Applicant: HON HAI PRECISION INDUSTRY CO., LTD., New Taipei (TW)

(72) Inventor: PO-CHOU CHEN, Tu-Cheng (TW)

(73) Assignee: HON HAI PRECISION INDUSTRY CO., LTD., New Taipei (TW)

(21) Appl. No.: 13/868,978

(22) Filed: Apr. 23, 2013

(30) Foreign Application Priority Data
Dec. 19, 2012 (TW) 101148539

(51) Int. Cl. F21V 8/00

(52) U.S. Cl. CPC G02B 6/0016
USPC 362/612; 362/611

(57) ABSTRACT

An edge-type backlighting module includes a light guiding plate, a lighting source, and a light coupler. The light guiding plate has a uniform thickness, and one end thereof acting as a combination end and a light input surface. A light output surface of the light guiding plate is perpendicular to the combination end. The light coupler has a first end and a second end opposite to the first end. The light coupler tapers from the first end to the second end. The lighting source is adhered to the first end. The second end is adhered to the combination end. An entirety of light emitted from the lighting source is transmitted to the light guiding plate via the light coupler.

### BACKGROUND

1. Technical Field

The present disclosure relates to edge-type backlighting modules, and more particularly to a low profile, edge-type LED (light emitting diode) backlighting module having a high light utilization efficiency of LEDs via the use of light couplers between the LEDs and a light guiding plate.

2. Description of Related Art

A conventional edge-type backlighting module includes a light guiding plate and a plurality of LEDs mounted on an end of the light guiding plate. The light guiding plate is rectangular and has a uniform thickness. Due to the low profile requirement of electronic devices, a thickness of the light guiding plate is made smaller and smaller. When a thickness of the light guiding plate is less than that of each of the LEDs, a part of light emitted from the LEDs can not enter the light guiding plate. Thus, a utilization efficiency of the light of the LEDs is reduced.

Accordingly, it is desirable to provide an edge-type backlighting module which can overcome the described limitations.

### BRIEF DESCRIPTION OF THE DRAWINGS

FIG. 1 is an isometric view of an edge-type backlighting module according to an exemplary embodiment of the present disclosure.

FIG. 2 is an isometric, enlarged view of a lighting module of the backlighting module of FIG. 1.

FIG. 3 is a cross sectional view of the lighting module of FIG. 2, taken along line thereof.

### DETAILED DESCRIPTION

Embodiments of an edge-type backlighting module 100 will now be described in detail below and with reference to the drawings.

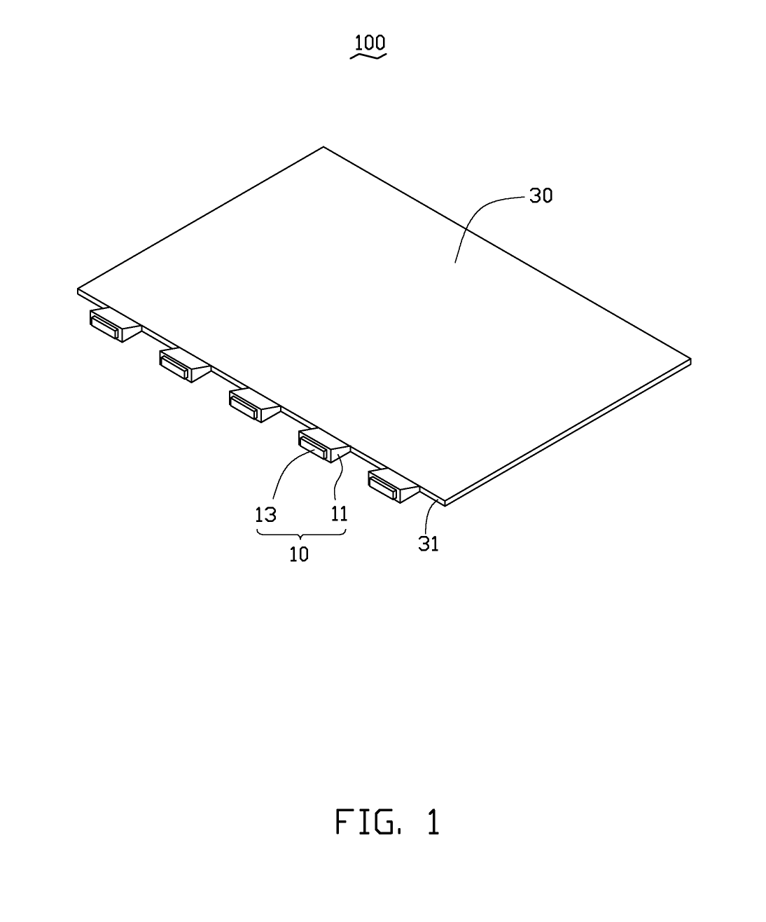

Referring to FIG. 1, the edge-type backlighting module 100 includes a plurality of lighting modules 10 and a light guiding plate 30 connecting the lighting modules 10.

The light guiding plate 30 is a thin rectangular plate and has a uniform thickness. The light guiding plate 30 is formed by press molding of polycarbonate (PC) or polymethyl methacrylate (PMMA). One end of the light guiding plate 30 acts as a combination end 31 to connect the lighting modules 10 thereon. The combination end 31 also functions as a light input surface of the light guiding plate 30. A top surface of the light guiding plate 30 shown in FIG. 1 functions as a light output surface thereof. The light output surface is perpendicular to the light input surface.

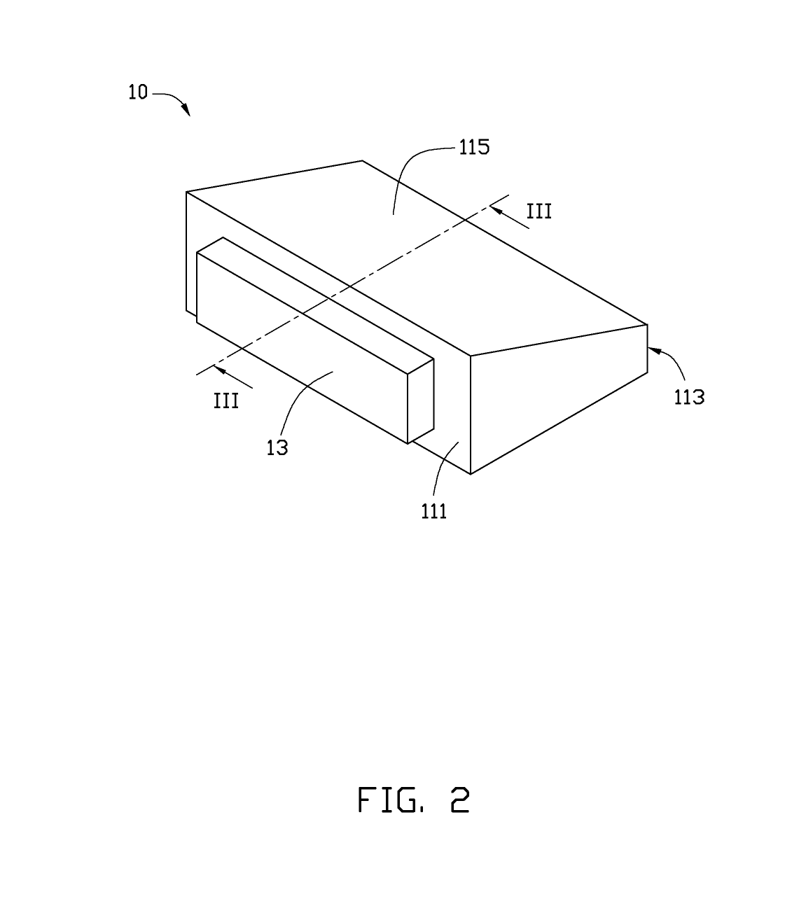

Referring to FIG. 2, the lighting modules 10 are spaced from each other and mounted on the combination end 31. Each lighting module 10 includes a light coupler 11 and an LED 13 mounted on the light coupler 11. A size of the light coupler 11 in real estate is larger than that of the LED 13 and far less than that of the light guiding plate 30. The light coupler 11 includes a first end 111 to connect the LED 13 and a second end 113 opposite to the first end 111 to connect the combination end 31 of the light guiding plate 30. A length of the first end 111 is larger than or equal to that of the LED 13. A thickness of the first end 111 is larger than or equal to that of the LED 13. The LED 13 is adhered to the first end 111. A boundary of the LED 13 is located within a boundary of the first end 111. A length of the second end 113 is less than that of the combination end 31. A thickness of the second end 113 is less than or equal to that of the combination end 31, i.e. the thickness of the light guiding plate 30. The second end 113 is adhered to the combination end 31. A boundary of the second end 113 is located within a boundary of the combination end 31.

In this embodiment, the light coupler 11 is a quadrangular prism and a transverse cross section thereof is trapezoidal. Each light coupler 11 tapers from the first end 111 to the second end 113. An end surface of the first end 111 and an end surface of the second end 113 are rectangular. The end surface of the first end 111 is larger than the end surface of the second end 113. The thickness of the second end 113 is equal to that of the combination end 31. When the second end 113 is adhered to the combination end 31, top and bottom edges of the second end 113 are respectively aligned with top end bottom edges of the light guiding plate 30. The thickness of the first end 111 is larger than that of the LED 13. The length of the first end 111 is larger than that of the LED 13. The LED 13 is adhered to a center of the first end 111.

In operation, the whole of light emitted from the LEDs 13 couples in the light couplers 11 from the first ends 111. The light in each of the light couplers 11 is totally reflected by top, bottom and lateral sides of the light coupler 11 to finally reach the second end 113 to enter the light guiding plate 30.

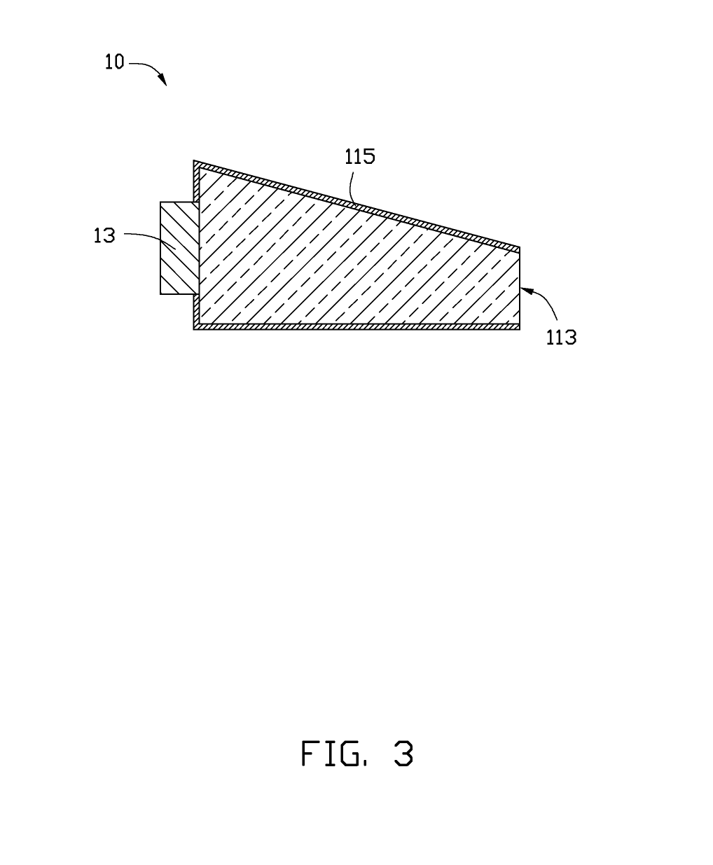

Referring to FIG. 3, to avoid the light emitted from the LED 13 from radiating out of the light coupler 11 except the second end 113, a reflecting film 115 is coated on an exterior of the light coupler 11 except the second end 113 and a part of the first end 111 where the LED 13 is adhered to. The reflecting film 115 is a silver film.

In this disclosure, because the entirety of the light emitted from the LEDs 13 is transmitted to the light guiding plate 30 via the light couplers 11, a utilization efficiency of the light of the LEDs 13 for the ultra-thin light guiding plate 30 is improved. Further, because the first end 111 and the second end 113 of the light coupler 11 respectively connect the LED 13 and the light guiding plate 30 and the thickness of the light guiding plate 30 is equal to that of the second end 113 and less than that of the first end 111, the light guiding plate 30 can suitable for low-profile electronic devices.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An edge-type backlighting module comprising:
a light guiding plate having a uniform thickness, and one end of the light guiding plate functioning as a combination end and a light input surface of the light guiding plate, a surface of the light guiding plate perpendicular to the light input surface functioning as a light output surface of the light guiding plate; and
a light module adhered to the combination end, the light module comprising a light coupler and an LED (light emitting diode), the light coupler comprising a first end and a second end opposite to the first end, the LED adhered to the first end and the second end adhered to the combination end, a thickness of the first end larger than that of the second end, a boundary of the LED located within a boundary of the first end, and a boundary of the second end located within a boundary of the combination end;
wherein an entirety of light emitted from the LED travels from the first end to the second end of the light coupler to be transmitted into the light guiding plate.

2. The edge-type backlighting module of claim 1, wherein the thickness of the first end is larger than or equal to that of the LED, a length of the first end is larger than or equal to that of the LED, a thickness of the second end is less than or equal to that of the combination end, and a length of the second end is less than that of the combination end.

3. The edge-type backlighting module of claim 1, wherein the light coupler tapers from the first end to the second end.

4. The edge-type backlighting module of claim 3, wherein the light coupler is a quadrangular prism, an end surface of the first end and an end surface of the second end are rectangular.

5. The edge-type backlighting module of claim 1, wherein the thickness of the second end is equal to that of the combination end, and top and bottom edges of the second end are respectively aligned with top end bottom edges of the light guiding plate.

6. The edge-type backlighting module of claim 1, wherein the thickness of the first end is larger than that of the LED, the length of the first end is larger than that of the LED, and the LED is adhered to a center of the first end.

7. The edge-type backlighting module of claim 1, wherein a reflecting film is coated on an exterior of the light coupler.

8. The edge-type backlighting module of claim 7, wherein the reflecting film is coated on the exterior of the light coupler except the second end and a part of the first end where the LED is adhered to.

9. The edge-type backlighting module of claim 7, wherein the reflecting film is a silver film.

10. An edge-type backlighting module comprising:
a light guiding plate having a uniform thickness, and one end of the light guiding plate functioning as a combination end and a light input surface of the light guiding plate, a surface of the light guiding plate perpendicular to the light input surface functioning as a light output surface of the light guiding plate;
a lighting source; and
a light coupler having a first end and a second end opposite to the first end, the light coupler tapering from the first end to the second end, the lighting source adhered to the first end, the second end adhered to the combination end, a boundary of the lighting source located within a boundary of the first end, and a boundary of the second end located within a boundary of the combination end;
wherein an entirety of light emitted from the lighting source travels from the first end to the second end of the light coupler to be transmitted into the light guiding plate.

11. The edge-type backlighting module of claim 10, wherein a thickness of the second end is equal to that of the combination end, and top and bottom edges of the second end are respectively aligned with top end bottom edges of the light guiding plate.

12. The edge-type backlighting module of claim 10, wherein a thickness of the first end is larger than that of the lighting source, a length of the first end is larger than that of the lighting source, and the lighting source is adhered to a center of the first end.

13. The edge-type backlighting module of claim 10, wherein a reflecting film is coated on an exterior of the light coupler.

14. The edge-type backlighting module of claim 10, wherein the reflecting film is a silver film.

15. An edge-type backlighting module comprising:
a light guiding plate with a uniform thickness, having a light input surface at a lateral side thereof and a light output surface at a top side thereof;
a light coupler having a first end remote from the light input surface of the light guiding plate and a second end adjacent to the light input surface of the light guiding plate, wherein the first end has a thickness larger than a thickness of the second end; and
an LED attached to the first end of the light coupler, wherein light generated by the LED is transmitted to the light guiding plate via the light coupler.

16. The edge-type backlighting module of claim 15, wherein the first and second ends of the light coupler are rectangular in shape and the light coupler tapers from the first end to the second end.

17. The edge-type backlighting module of claim 15, further comprising a reflective film coated on an exterior of the light coupler.

18. The edge-type backlight module of claim 15, wherein the second end of the light coupler has a top coplanar with the top side of the light guiding plate and a bottom coplanar with a bottom side of the light guiding plate.
